(19) United States
(12) Patent Application Publication
(10) Pub. No.: US 2023/0330679 A1
(43) Pub. Date: Oct. 19, 2023

(54) DISPOSABLE CARTRIDGE

(71) Applicant: PROLIGHT DIAGNOSTICS AB, Lund (SE)

(72) Inventors: Oliver Ferguson, Cambridgeshire (GB); Benjamin James Metcalf, Royston (GB); Neil Pollock, Royston (GB); Andrew Malloy, Royston (GB)

(73) Assignee: PROLIGHT DIAGNOSTICS AB, Lund (SE)

(21) Appl. No.: 17/919,698

(22) PCT Filed: Apr. 6, 2021
(86) PCT No.: PCT/GB2021/050849

§ 371 Date: Oct. 18, 2022

(30) Foreign Application Priority Data
Apr. 6, 2020 (GB) 2005011.8

(51) Int. Cl. B01L 3/00; B01L 9/06

(52) U.S. Cl. CPC B01L 3/563; B01L 9/06; B01L 2200/026; B01L 2200/04; B01L 2200/0689; B01L 2300/044; B01L 2300/0672; B01L 2400/0487

(57) ABSTRACT

A disposable cartridge for processing a biological fluid sample, the cartridge comprising: a sample holder configured to hold a collection tube containing the sample; an extractor configured to engage with the collection tube to transfer the sample from the collection tube to the cartridge; and a sample processor for processing the sample.

### TECHNICAL FIELD

The disclosure relates to in-vitro primary-sample delivery, in particular to the case where the primary sample is taken using a sample collection tube and it is desired to use this sample for further downstream processing (for example in diagnostics, therapeutics, sample preparation). This disclosure also relates to consumable cartridges which require a sample delivery mechanism.

### BACKGROUND

Many analytical systems routinely involve collecting, processing and analysing bodily fluids such as blood, urine, spinal fluid etc. Often these analytical systems comprise a disposable cartridge which processes the fluid and an analytical instrument that automates the functioning of the cartridge. A requirement of many of these systems is the need for simple and safe sample collection and the subsequent transfer to the disposable cartridge without sample contamination or exposure of personnel to hazardous materials.

Further, the continuing expansion of analytical systems designed to be used by untrained persons at the point of care makes proper sample handling increasingly important for the generation of reliable and accurate results from these systems.

Blood is a common sample source and this is often taken directly from the patient using a collection tube comprising a self-sealing septum. Such a collection tube allows for the safe and reliable drawing of blood from a patient and the self-sealing septum is effective in preventing spills or sample contamination. As such, these primary sample collection tubes are very common within the healthcare sector. The collection tube often comprises a fixed vacuum section, or requires the user to create a vacuum in use (e.g. the Sarstedt Monovette), in order to improve insulation.

However, the transfer of blood samples from such a primary sample collection tube to an analysis instrument often requires de-capping the tube and drawing out the blood manually using a syringe or pipette before using this to transfer the sample. These additional processes required for transfer of the sample greatly increase the risk of sample loss, sample contamination or sample degradation, especially when performed by untrained persons.

### SUMMARY

In view of the above, the inventors have considered how to provide an improved method of directly transferring a sample from a collection tube directly into a disposable analytical cartridge.

According to a first aspect, the present disclosure provides a disposable cartridge for processing a biological fluid sample, the cartridge comprising: a sample holder configured to hold a collection tube containing the sample; an extractor configured to engage with the collection tube to transfer the sample from the collection tube to the cartridge; and a sample processor for processing the sample.

Optionally, the cartridge comprises a first channel for transporting a driving fluid into the collection tube and a second channel for transporting the sample out of the collection tube, wherein the extractor is configured to replace at least a part of the sample with the driving fluid in the collection tube.

Optionally, the cartridge is configured for use with a collection tube that comprises a septum, and the extractor comprises one or more needles configured to connect to the first and second channels.

Optionally, the one or more needles are flat-tipped with a hollow core.

Optionally, the one or more needles have an outer diameter of between 0.3 mm and 1 mm, and an inner diameter of between 0.15 mm and 0.6 mm, preferably an outer diameter of 0.64 mm and an inner diameter of 0.34 mm.

Optionally, the one or more needles comprises a first needle configured to connect to the first channel and a second needle configured to connect to the second channel.

Optionally, one of the first needle and second needle extends beyond an end of the other of the first needle and second needle, preferably by at least 5 mm.

Optionally, the extractor comprises a recess configured to engage with the collection tube, or the extractor comprises a hub configured to engage with a recess in the collection tube.

Optionally, the cartridge further comprises a syringe connected to the first channel and configured to drive the driving fluid into the collection tube.

Optionally, the driving fluid is air and the cartridge further comprises an inlet for drawing air into the syringe.

Optionally, the cartridge further comprises a fluid connector connected to the first channel and configured to engage with an external driver for driving the driving fluid into the collection tube.

Optionally, the cartridge further comprises a re-orientation mechanism configured to re-orient the collection tube and configured to connect the extractor to the sample processor.

Optionally, the extractor is configured to engage with a first end of the collection tube and the re-orientation mechanism is configured to re-orient the collection tube such that the first end is lower than a centre of the collection tube.

Optionally, the re-orientation mechanism comprises a first fluid directing element surrounding a second fluid directing element, wherein the first fluid directing element is configured to rotate around the second fluid directing element, and the first and second fluid directing elements are configured to configured to connect the extractor to the sample processor when the first fluid directing element is in a first rotation position.

Optionally, the re-orientation mechanism further comprises a sealed channel between the first fluid directing element and the second fluid directing element, the sealed channel being configured to connect the extractor to the sample processor when the first fluid directing element is in any of a plurality of rotation positions.

Optionally, the second fluid directing element is connected to a plurality of sample processors, and re-orientation mechanism is configured to connect the extractor to different sample processors when the first fluid directing element is in different rotation positions.

Optionally, the re-orientation mechanism comprises a flexible hose configured to connect the extractor to the sample processor.

Optionally, the re-orientation mechanism further comprises a lock configured to prevent re-orientation of the collection tube when engaged.

Optionally, the lock is configured to disengage when operated by a second actuator.

Optionally, the sample holder is configured to receive a first actuator to drive the collection tube to engage with the extractor.

Optionally, the sample processor comprises a rotatable container for centrifugation.

According to a second aspect, the present disclosure provides an instrument for operating a disposable cartridge for processing a biological fluid sample, the cartridge comprising: a sample holder configured to hold a collection tube containing the sample; an extractor configured to engage with the collection tube to transfer the sample from the collection tube to the cartridge; and a sample processor for processing the sample, the instrument comprising: a first actuator configured to drive the collection tube to engage with the extractor.

Optionally, the instrument is for operating a disposable cartridge further comprising a first channel for transporting a driving fluid into the collection tube and a second channel for transporting the sample out of the collection tube, wherein the extractor is configured to replace at least a part of the sample with the driving fluid in the collection tube, the instrument further comprising: a driver configured to engage with a fluid connector of the cartridge connected to the first channel and to drive the driving fluid into the collection tube.

Optionally, the instrument is for operating a disposable cartridge further comprising a re-orientation mechanism configured to re-orient the collection tube and configured to connect the extractor to the sample processor, the instrument further comprising: a second actuator configured to operate the re-orientation mechanism.

Optionally, the instrument is for operating a disposable cartridge wherein the re-orientation mechanism further comprises a lock configured to prevent re-orientation of the collection tube when engaged, wherein: the second actuator is further configured to disengage the lock.

### BRIEF DESCRIPTION OF THE DRAWINGS

FIG. 1 is a schematic cut-through perspective illustration of a disposable cartridge according to a first embodiment;

FIGS. 2A to 2C are schematic illustrations of the extractor of the cartridge;

FIGS. 3A and 3B are schematic illustrations of how the extractor is supported on a mount in one embodiment;

FIGS. 4A to 4C are schematic cut-through perspective illustrations of a process of transferring a sample from the collection tube to the cartridge;

FIGS. 5A and 5B are schematic illustrations of a sample in the collection tube;

FIGS. 6A and 6B are schematic illustrations of a mechanism for driving a driving fluid into the collection tube and extracting the sample;

FIG. 7 is a schematic illustration of a second example of a re-orientation mechanism for the cartridge;

FIG. 8 is a schematic illustration of a third re-orientation mechanism for the cartridge;

FIGS. 9A to 9E are schematic illustrations of the guard and the sample holder;

FIGS. 10A to 10E are schematic illustrations of a process of disengaging the lock between the guard and the sample holder;

FIGS. 11A and 11B are schematic illustrations of a process of re-engaging the lock;

FIGS. 12A to 12C are schematic illustrations of an instrument for operating the cartridge;

### DETAILED DESCRIPTION

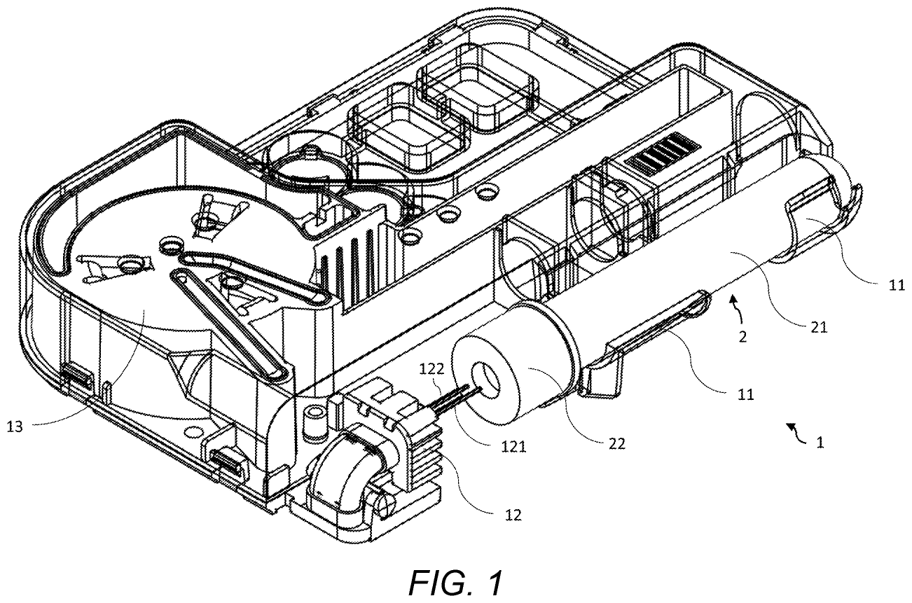

FIG. 1 is a schematic cut-through perspective illustration of a disposable cartridge according to a first embodiment.

The cartridge 1 comprises a sample holder 11, an extractor 12 and a sample processor 13. The cartridge 1 is a disposable structure designed to be used once or used a limited number of times. The cartridge 1 may for example be made from a polymer such as a polypropylene or a polycarbonate. The cartridge may be moulded as a single body or as multiple components which are then connected together.

The sample holder 11 is configured to hold a collection tube 2 containing a biological fluid sample. For example, the collection tube may be a vacuum tube (aka vacutainer) containing a sample of blood. The sample holder 11 may for example take the form of a cradle which supports the collection tube 2 in a position ready to engage with the extractor 12.

As shown in FIG. 1, in this example the sample holder 11 additionally comprises a clip which extends partly around the collection tube 2 such that the collection tube can be securely held in the cartridge 1 until the tube 2 and cartridge 1 are operated for processing the sample. In other embodiments, the sample holder 11 may only support the collection tube 2 without securely holding the tube 2.

In this case, the collection tube 2 is a vacuum tube (aka vacutainer) containing a sample of blood, although the cartridge can be configured for use with many types of commercially available collection tube, and for samples of other biological fluids such as urine. The vacuum tube comprises a cylindrical body 21 having an inner container surrounded by vacuum insulation, and further comprises a cap 22. The cap 22 in this case comprises a self-resealing septum (made for example from an elastomer, such as silicone elastomers, PTFE-based seals, or rubber) and can be attached to the cylindrical body 21 to secure the sample. In other embodiments, the cap 22 may have a different type of opening. For example, the cap 22 may comprise one or more valves adapted to be opened by the extractor 12.

The extractor 12 is configured to engage with the collection tube 2 to transfer the sample to the cartridge 1. The extractor in this example comprises two needles which are arranged to pierce the septum in the cap 22 of the collection tube 2. A first needle 121 conveys a driving fluid that is driven into the collection tube. This driving pressure forces fluid (i.e. the sample) out of the collection tube 2 through the second needle 122. Other extraction mechanisms could be used as an addition or alternative to this pressure-based transfer in a sealed fluid system. For example, the extractor could be configured to automate a conventional method of analysing samples by de-capping the tube and drawing out the blood using a syringe or pipette. Furthermore, the cap 22 may comprise one or more valves adapted to be opened by the first or second needle 121, 122.

The driving fluid is preferably less dense than the sample and may, for example, be air or an inert gas. This is because of the gravitational aspect of how the cartridge 1 performs extraction of the sample, as explained further below.

The sample processor 13 is for processing the sample. For example, as illustrated in FIG. 1, the sample processor 13 may comprise a rotatable container for centrifugation, such as a pot, as described for example in prior application GB1913321.4, although the invention may be implemented to provide a cartridge with any sample processor. Additionally, the sample processor 13 may simply provide a connection to an external sample processor. For example, a modular cartridge system may be employed in which a cartridge according to the invention, having the sample holder 11 and the extractor 12, connects to a second cartridge having a sample processor.

The sample processor 13 is connected to the extractor 12 within the cartridge 1 via one or more fluid channels, which may for example be microfluidic channels. The cartridge 1 may additionally be configured to transport the sample, or a product of processing the sample, to an external instrument or to a second cartridge configured to perform further processing of the sample.

The disposable cartridge 1 may additionally comprise one or more cover elements, for example a housing surrounding or covering the sample processor 13.

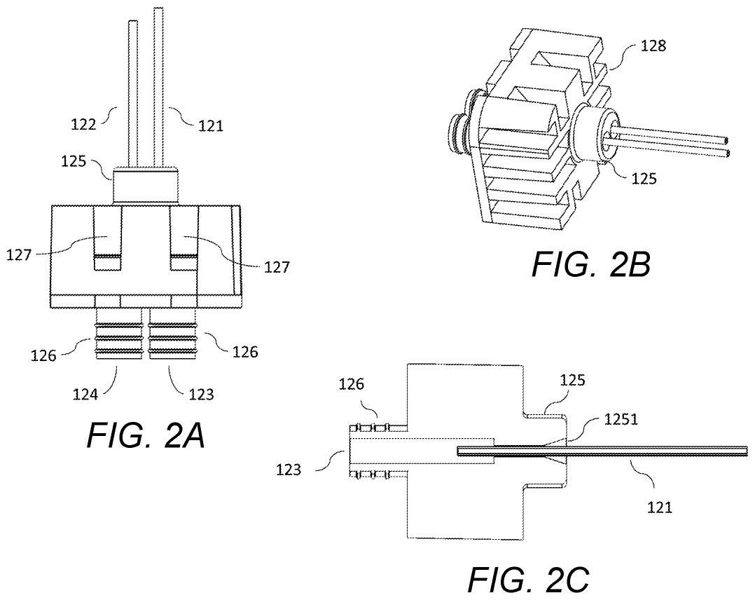

FIGS. 2A to 2C are schematic illustrations of the extractor 12 of the cartridge 1.

As shown in more detail in FIGS. 2A to 2C, the extractor 12 connects the first needle 121 to a first channel 123 for transporting a driving fluid (such as air) into the collection tube 2, and connects the second needle 122 to a second channel 124 for transporting the sample out of the collection tube 2. The collection tube 2 is closed apart from the engagement with the extractor 12 and thus the driving fluid displaces the sample and forces the sample into the second channel 124.

Each of the first and second needles 121, 122 may appropriately have a length of between 10 mm and 50 mm, most preferably around 25 mm. The first needle 121 preferably extends at least 5 mm beyond the end of the second needle 122. Alternatively, the second needle 122 may be longer than the first needle 121. Either way, having needles of different lengths reduces a peak piercing force required for the extractor 12 to pierce the septum of the collection tube, because the first and second needles 121, 122 pierce the septum at different times.

The first and second needles 121, 122 are preferably blunt-tip needles with a hollow core. The needles may, for example, be made from steel, high strength bio-compatible metals such as titanium, metal alloys such as Incotel, or bio-compatible engineering polymers such as PEEK—Polyether ether ketone, PPO—Poly(p-phenylene oxide) and PBT—Polybutylene terephthalate. By comparison to slanted tip needles, blunt tips increase the required piercing force for the extractor 12 to engage with the collection tube 2, but greatly improve safety by reducing the risk of needle-stick injury to a user. Slanted tip needles may alternatively be used in combination with a guard for reducing the chance of user injury.

For application with common biological fluids such as blood, the first and second needles 121, 122 may appropriately have an outer diameter of between 0.3 mm and 1 mm, most preferably around 0.5 mm or around 0.64 mm, and an inner diameter of between 0.15 mm and 0.6 mm, most preferably around 0.3 mm or around 0.34 mm. These dimensions are suitable as a compromise between required piercing force, likelihood of damaging the septum of the collection tube 2, likelihood of blocking the needle with a portion of the septum, and the achievable flow rate in the needles.

The first and second needles 121, 122 are embedded in a hub 125. The hub 125 provides a solid point of engagement for the collection tube 2 and thus reduces any stress on the needles 121, 122, which do not need to support any weight of the collection tube 2. The first and second needles 121, 122 are preferably positioned closely together to reduce the total required piercing force. In other embodiments, the needles 121, 122 may be reinforced such that they are able to support the collection tube 2 in addition to performing their fluid transport functions.

In this embodiment, the hub 125 comprises a reverse taper 1251 to assist with assembling a needle in the hub 125. The needle may be attached to the hub using an adhesive, such as a UV-curable adhesive. Additionally, the needles 121, 122 may be subjected to high forces during piercing of the collection tube 2, and therefore the needles need to be appropriately secured. The adhesive may therefore fill the reverse taper 1251 to provide high resistance to the piercing forces. Alternatively, more elaborate bonding methods could be used, for example allowing the adhesive to wick into the hub 125 to form an even more rigid bond. Alternatively, the needles 121, 122 could be insert moulded within the hub 125 during manufacture.

As an alternative to the hub 125, the extractor 12 may comprise a recess that is adapted to (at least partly) surround and engage with a part of the collection tube 2. When engaged with the collection tube, the hub 125 or recess also has the advantage of improving sealing of the collection tube 2 in the case that the septum does not entirely reseal around the needles 121, 122.

In this embodiment, the extractor 12 is a self-contained component comprising fluid attachment means 126 (e.g. ports with ribbed outer surfaces) for fluid connection to the cartridge 1 and mechanical attachment means 127 (e.g. protrusions or recesses configured to interlock with the cartridge 1).

Additionally, a body of the extractor 12 has a fin structure 128. This reduces the weight and amount of material required for the extractor 12. The fin structure 128 may also allow greater accuracy in cases where the extractor 12 is formed by moulding, by allowing for improved uniformity of wall thickness.

Other configurations of the extractor 12 are possible. For example, the first and second needles 121, 122 may be replaced with a single needle comprising a divided channel, such as inner and outer concentric channels, or channels divided by a diameter of the needle.

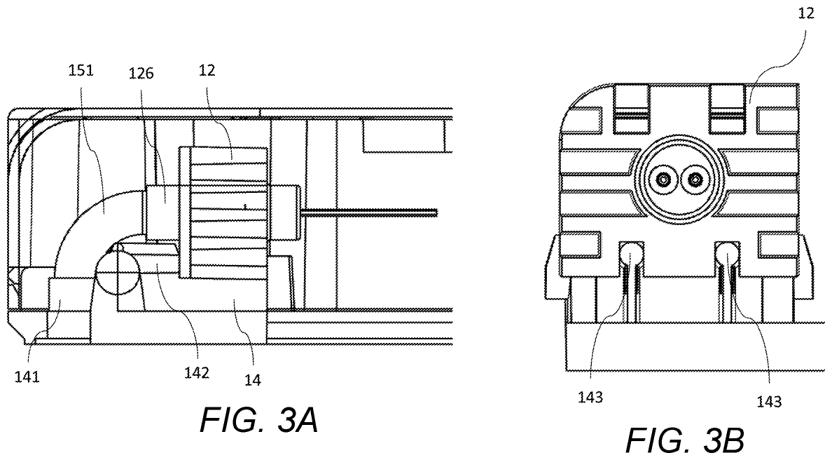

FIGS. 3A and 3B are schematic illustrations of how the extractor 12 is supported on a mount 14 in one embodiment.

Each of the fluid attachment means 126 is attached to a respective fluid port 141 via a flexible hose 151. Thus the extractor 12 is connected to the sample processor 13 via the hose 151.

The mount 14 additionally comprises a reaction element 142 configured to provide a reaction force and hold the extractor 12 in place when the needles 121, 122 are used to pierce the septum of the collection tube 2. This may simply be a section of the mount 142 that extends “behind” the extractor 12 relative to the needles 121, 122.

The mount 14 additionally comprises mechanical attachment means 143 configured to attach to the corresponding mechanical attachment means 127 of the extractor 12. For example, the mount 14 may have a guide rail 143, and the extractor 12 may have a slot 127 adapted to slide along the guide rail 143.

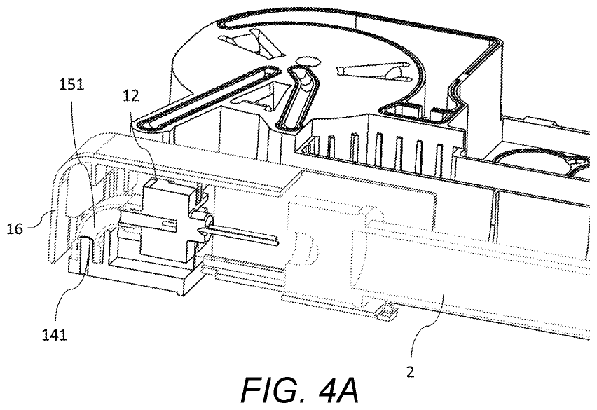

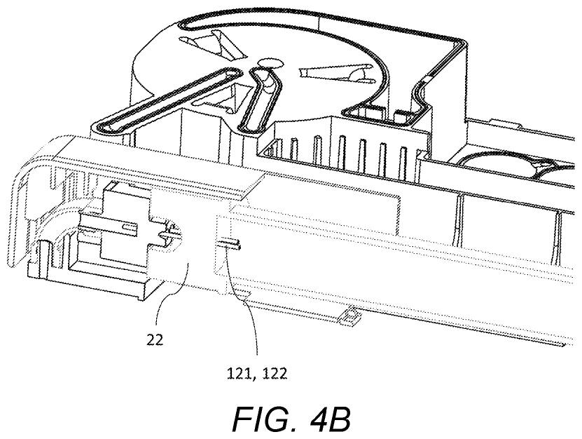

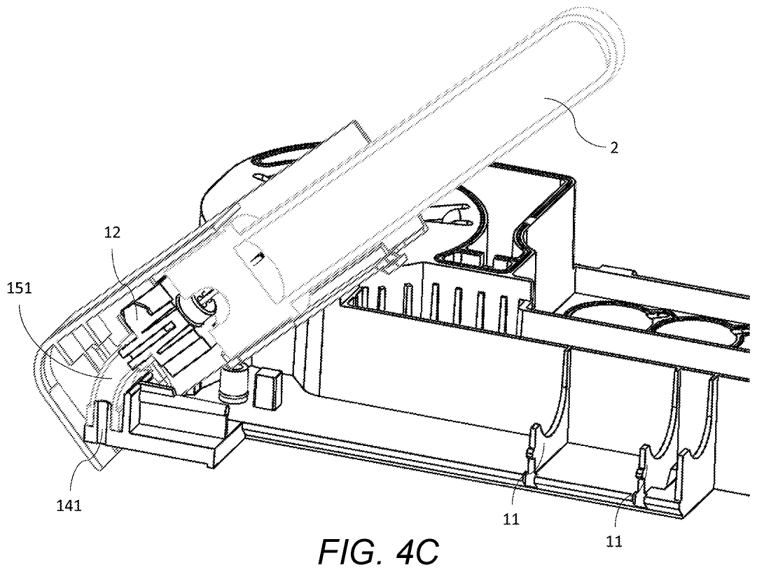

FIGS. 4A to 4C are schematic cut-through perspective illustrations of a process of transferring a sample from the collection tube 2 to the cartridge 1.

In FIG. 4A, a cross-section plane is shown through the collection tube 2 and the extractor 12, when the tube 2 is loaded in the sample holder 11 ready for extraction of the sample.

As shown in FIG. 4A, the cap 22 of the collection tube 2 comprises a recessed central portion which provides a thick septum membrane that can be pierced by the first needle 121 and the second needle 122, and can re-seal itself. The re-sealing property of the membrane has the advantage that the septum remains fluid-sealed while the extractor 12 is engaged with the tube 2, and the tube 2 does not leak when it is removed from the cartridge 1. However, in other embodiments, a single-use collection tube 2 may have a lid that allows penetration by the needles 121, 122, but is not resealable.

As also shown in FIG. 4A, the cartridge 1 may optionally comprise a guard 16 arranged as a partial housing for extractor 12, in order to improve safety in the case of a user providing the collection tube 2 in the sample holder 11, and also to protect the needles 121, 122 from damage in the case that the cartridge suffers an impact.

The guard 16 may be configured to interface with the extractor 12, for example via the mechanical attachment means 127 or the fin structure 128. This interfacing has the effect that the guard 16 is re-oriented simultaneously with the collection tube 2. A cartridge 1 with this interfacing can also be easily assembled. The extractor 12 may first be seated on the mount 14 and then the guard 16 may be secured to the extractor 12, for example using a snap fit connection.

The guard 16 is open towards the sample holder 11, such that a collection tube 2 can move to engage with the extractor 12, as shown in FIG. 4B.

In FIG. 4B, the needles 121, 122 extend through the cap 22 (specifically penetrating through the septum) and into the collection tube 2 to access the sample.

In FIG. 4C, a re-orientation mechanism 15 (not fully shown, but comprising the flexible hose 151), has re-oriented the collection tube 2 while maintaining a connection between the extractor 12 and the sample processor 13 (via the flexible hose 151 and the fluid port 141). The re-orientation mechanism 15 may in one example comprise a hinge attached between the extractor 12 and a main body of the cartridge 1. This re-orientation assists with extraction of the sample from the collection tube 2 into the cartridge 1, as explained below.

More specifically, in some embodiments of the cartridge 1, it is possible to load the collection tube 2 in a position where it remains at a fixed angle relative to the horizontal, which usually corresponds to a plane of the cartridge 1. The fixed angle may, for example, be 90 degrees.

However, in other cases, it is not possible to load the collection tube 2 into the cartridge 1 at the fixed angle used for extraction. This could, for example, be due to difficulties in operating fluidic channels that are required in the cartridge against the effects of gravity. Loading the collection tube 2 at a different orientation from the cartridge 1 can in some cases create difficulties for interfacing with an instrument or disposing of the tube and cartridge as a combination. Additionally, if the collection tube 2 and the cartridge 1 are at different orientations during preparation, this presents a lever which increases the chance of damaging the needles 121, 122 or the cartridge 1 generally, for example if a weight is exerted on the tube 2 or cartridge 1. Therefore, the inventors expect that it is often useful to have a built-in mechanism for re-orientation of the collection tube 2 in the cartridge 1, and to load the collection tube 2 into the cartridge 1 at whatever orientation is most convenient, before re-orienting the collection tube 2 to a desired angle for extraction of the sample.

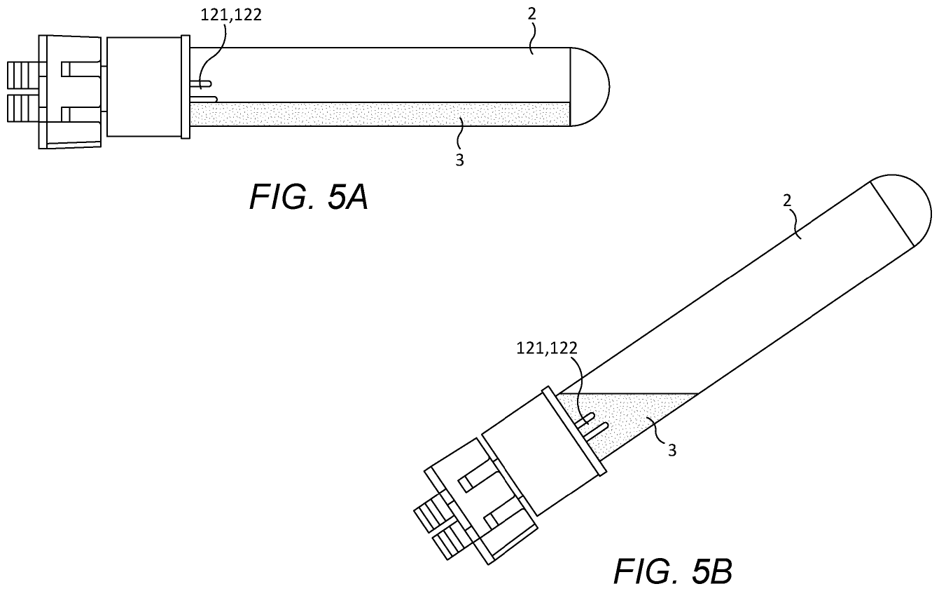

FIGS. 5A and 5B are schematic illustrations of a sample in the collection tube.

In FIG. 5A, the collection tube 2 is horizontal, and the sample 3 collects at a bottom of the collection tube 2. As a result, a certain quantity of the sample 3 is below the levels of the needles 121, 122 when the extractor 12 is engaged with the collection tube 2, and the certain quantity cannot be extracted, reducing the quantity of the sample 3 which can be analysed.

In FIG. 5B, the collection tube 2 is re-oriented such that a first end of the collection tube 2, at which the extractor 12 engages with the collection tube 2, is lower than a centre of the collection tube 2. In this position, the sample 3 collects towards the first end of the collection tube 2, and the certain quantity that cannot be extracted is reduced. The re-oriented position may be at up to 90 degrees to the horizontal of FIG. 5A, but in many cases a smaller angle such as 30 degrees is sufficient.

Having the first needle 121 longer than the second needle 122 has the further advantage that, in the raised position, flow of the driving fluid from the first needle 121 does not impede the sample from entering the second needle 122.

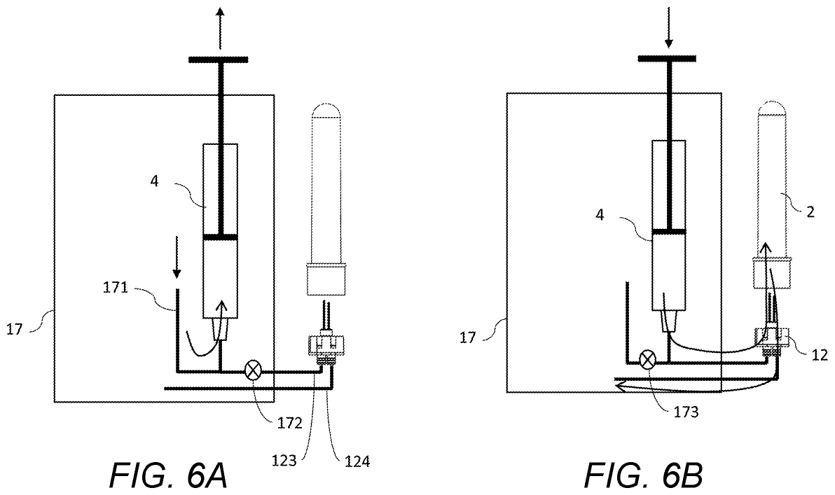

FIGS. 6A and 6B are schematic illustrations of a mechanism 17 for driving a driving fluid into the collection tube 2 and extracting the sample.

In the embodiment schematically shown in FIGS. 6A and 6B, the cartridge 1 further comprises a syringe 4 connected to the first channel 123 of the extractor 12. As shown using arrows in FIG. 6B, the driving fluid may be driven by the syringe 4 into the collection tube 2. This displaces the sample 3 which then passes into the second channel 124 of the extractor 12.

The syringe 4 may be provided as part of the cartridge 1, pre-filled with the driving fluid. This has the advantage that there is no danger that the driving fluid is contaminated when coming from an external source.

Alternatively, the driving fluid may be air that is drawn into the cartridge 1 through an inlet 171 to the syringe 4 in a first stage where a plunger of the syringe is pulled, as shown in FIG. 6A, and then driven into the collection tube 2 in a second stage where the plunger is pushed, as shown in FIG. 6B.

The inlet 171 and the first channel 123 may each comprise a valve 172, 173. In the first stage of FIG. 6A, the valve 172 is closed in the first channel 123, so that the driving fluid is drawn into the syringe 4. In the second stage of FIG. 6B, the valve 173 is closed in the inlet 171, so that the driving fluid is driven into the collection tube 2. The valves 172, 173 may, for example, be one-way valves so that the driving fluid is transferred forward through the inlet 171 and then the first channel 123.

As a further alternative, the syringe may be omitted, and the cartridge 1 may comprise an inlet 171 simply connected to the first channel 123, where the inlet comprises a fluid connector configured to engage with an external driver 4, such as a separate syringe, a source of compressed air (either a live compressor or a container of previously compressed air), or a source of another driving fluid such as an inert gas. In such embodiments, the external driver drives the driving fluid into the collection tube 2 via the inlet 171 and the first channel 123.

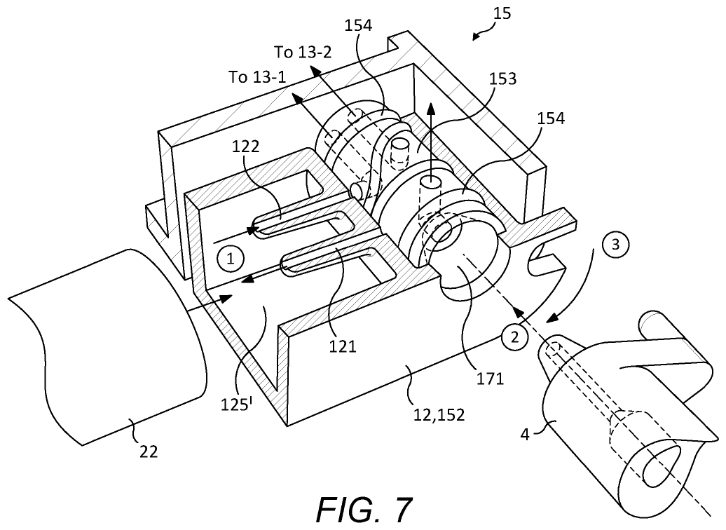

FIG. 7 is a schematic illustration of a second example of a re-orientation mechanism 15 for the cartridge 1.

In the second example, the re-orientation mechanism 15 comprises a first fluid directing element 152 surrounding a second fluid directing element 153, where the first fluid directing element 152 is merged with the extractor 12 in an embodiment where the extractor comprises a recess configured to engage with the cap 22 of the collection tube 2.

The first fluid directing element 152 is configured to rotate around the second fluid directing element 153 in order to re-orient the collection tube 2.

The first and second fluid directing elements 152, 153 provide a fluid connection between the extractor 12 and the sample processor 13. Specifically, in this example, depending on a rotation position of the first fluid directing element 152, the second needle 122 may be connected to any of multiple different sample processors 13-1 and 13-2 via the second fluid directing element 153. For example, the sample processor 13-1 may be simply a waste disposal system used to empty the collection tube 2 and the sample processor 13-2 may be a rotatable container for centrifugation. More generally, the extractor 12 may be connected to any of a plurality of different sample processors at different rotation positions. Additionally or alternatively, the re-orientation mechanism 15 may connect the extractor 12 to a single sample processor 13 at one rotation position and disconnect the extractor 12 from the sample processor 13 another rotation position.

In this example, the re-orientation mechanism further comprises a sealed channel between the first fluid directing element 152 and the second fluid directing element 153. Specifically, the sealed channel may be provided by one or more elastomer rings 154 (e.g. o-rings) arranged between the first and second fluid directing elements. Alternatively, rather than arranging seals between the first and second fluid directing elements, seals could be formed as spacer elements protruding from either of the first fluid directing element 152 and the second fluid directing element 153. In this alternative, the sealed channel may for example be defined by integral rib protrusions or over-moulded elastomer portions on the first and/or second fluid directing element. By providing a sealed channel, the extractor 12 may be connected to a sample processor 13-1 or 13-2 when the first fluid directing element 152 is in any of a plurality of rotation positions (e.g. an angular range of rotation positions).

More specifically, in the example of FIG. 7, three (3) sealed channels are provided. In a first sealed channel, an inlet in the second fluid directing element 153 is connected to the first needle 121. A second sealed channel defines a limited angular range of rotation positions in which the second needle 122 is connected to a first sample processor 13-1. A third sealed channel defines a limited angular range of rotation positions in which the second needle 122 is connected to a second sample processor 13-2.

Additionally, in this example, the inlet 171 is provided in the second fluid directing element 153 to engage with an external driver 4 to drive the driving fluid, and the first fluid directing element 152 is configured to engage with the external driver 4 to control the rotation position of the first fluid directing element 152 relative to the second fluid directing element 153. This has the effect that a single external tool can both operate the re-orientation mechanism 15 and drive the driving fluid. However, in other embodiments such adaptations for an external driver 4 may be omitted.

The numbered bubbles 1, 2 and 3 indicate a sequence of operations for this second example of the re-orientation mechanism 15. First, the extractor 12 and the collection tube 2 engage with each other. Second, the external driver 4 engages with the inlet 171. Third the external driver 4 rotates to operate the re-orientation mechanism 15.

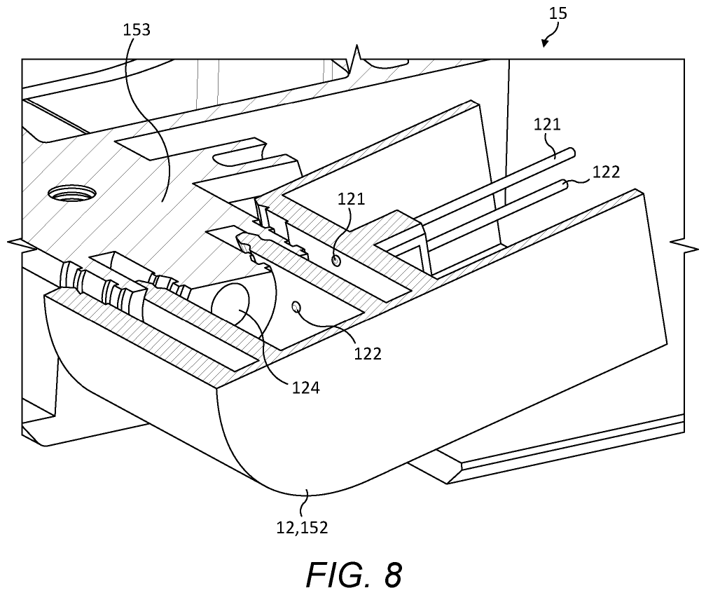

FIG. 8 is a schematic illustration of a third re-orientation mechanism for the cartridge.

The third re-orientation mechanism is configured as a double-concentric rotating fluid seal, in which the first and second fluid directing elements 152, 153 enclose two concentric channels. The inner channel connects the second needle 122 to the second channel 124 and on to the sample processor 13. On the other hand, the outer channel connects the first needle 121 to the first channel 123 through which the driving fluid is driven. In the third re-orientation mechanism, the extractor 12 is connected to the sample processor 13 regardless of the rotation angle of the re-orientation mechanism 15.

In other embodiments, the sealed channel may be omitted, and the extractor 12 may be connected to the sample processor 13 only in discrete positions of the re-orientation mechanism 15.

For any of the embodiments that include a re-orientation mechanism 15, the inventors have noted that it is advantageous to be able to secure the re-orientation mechanism 15 against the user accidentally re-orienting the collection tube 2 before they are ready to do so deliberately. For example, a freely moving re-orientation mechanism 15 may increase the chance of the collection tube 2 swinging free from the cartridge 1 or colliding with an external object.

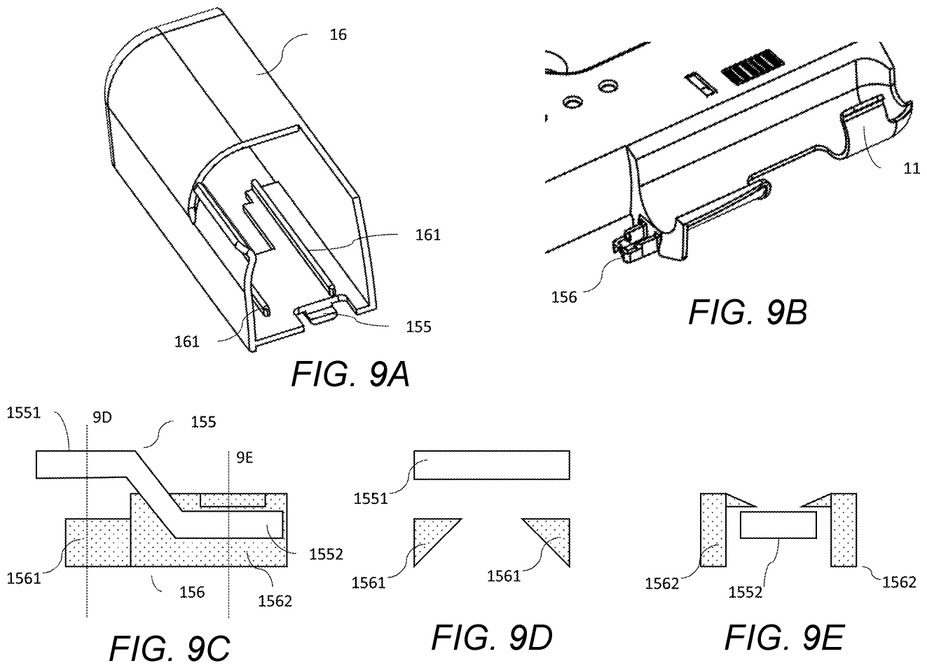

FIGS. 9A to 9E are schematic illustrations of the guard 16 and the sample holder 11 comprising a lock for the re-orientation mechanism 15 to prevent such free movement.

As shown in FIG. 9A, the guard 16 comprises a first lock element 155 which protrudes towards the sample holder 11 in the cartridge 1 in an embodiment. Similarly, as shown in FIG. 9B, the sample holder 11 comprises a second lock element 156 which protrudes towards the guard 16 in the cartridge 1. The first and second lock elements provide a lock for the re-orientation mechanism 15 that is configured to prevent re-orientation of the collection tube when the lock is engaged.

As also shown in FIG. 9A, the guard 16 may comprise one or more guides 161 for guiding the collection tube 2 to engage with the extractor 12.

FIGS. 9C to 9E show how the first and second lock elements 155, 156 fit together when the lock is engaged. FIG. 9C is a cross-section parallel to the direction along which a collection tube 2 engages with the extractor 12, and thus parallel to the guide 161 in the guard 16 and parallel to an open direction in the sample holder 11. FIGS. 9D and 9E are perpendicular cross-sections to FIG. 9C, at the lines 9D and 9E that are marked in FIG. 9C.

The first lock element 155 comprises a first portion 1551 which is attached to, or part of, a plane of a main body of the guard 16, and a second portion 1552 which is offset from the plane of the main body of the guard, such that portion 1551 moves ahead of portion 1552 in a re-orientation direction when the re-orientation mechanism 15 is operated to extract the sample.

The second lock element 156 comprises a lock disengaging portion 1561 and a lock engaging portion 1562. The lock disengaging portion 1561 is configured to release the lock when operated by an actuator (explained below). The lock engaging portion 1562 is configured to inhibit motion of the second portion 1552 of the first lock element 155 when the lock is engaged, and to lock onto the second portion 1552 when the re-orientation mechanism 15 is operated to replace the collection tube 2 after sample extraction.

The first and second lock elements 155 and 156 are merely examples, and any other lock may be used to secure the re-orientation mechanism 15 until disengaged. Furthermore, the lock may be omitted in some embodiments.

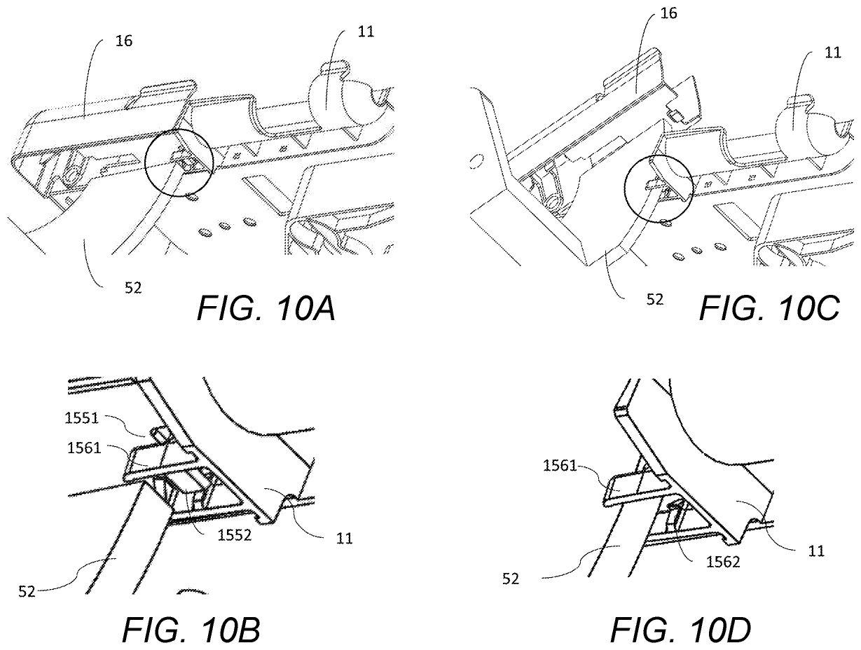

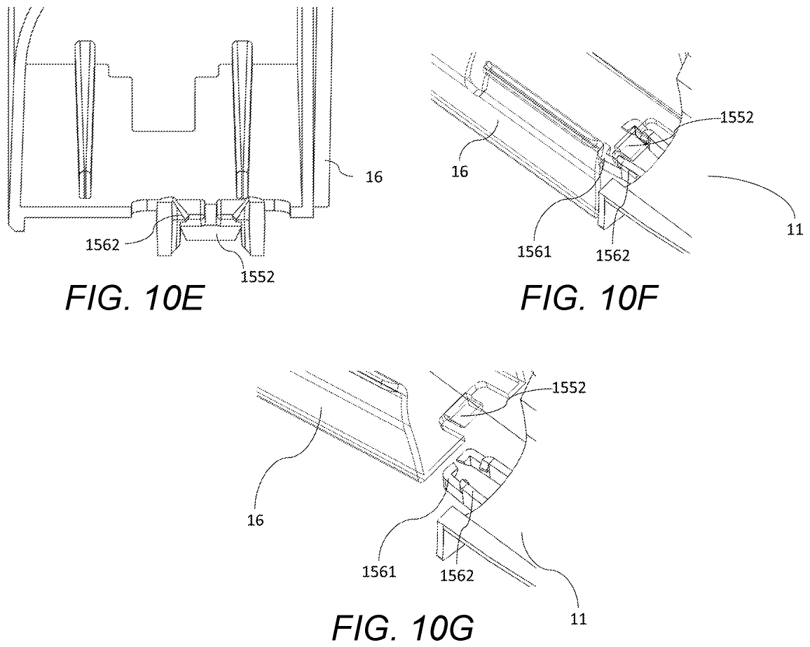

FIGS. 10A to 10G are schematic illustrations of a process of disengaging the lock between the guard 16 and the sample holder 11.

FIG. 10A shows an actuator 52 ready to release the lock between the guard 16 and the sample holder 11.

FIG. 10B is a zoomed in view of the lock of FIG. 10A, in the circle marked on FIG. 10A. As shown in FIG. 10B, at this stage, the actuator 52 is aligned with the lock disengaging portion 1561, and the second portion 1552 of the first lock element 155 extends beyond the actuator 52. Furthermore 10B shows that, in this embodiment, when the lock is engaged, the lock disengaging portion 1561 is located below a plane of the guard 16 comprising the first portion 1551 of the first lock element 155.

FIG. 10C shows the actuator 52 after releasing the lock, where the re-orientation mechanism 15 has been operated to re-orient the guard 16 (and re-orient a collection tube 2 if it has been engaged with the extractor 12).

FIG. 10D is a zoomed in view of the second lock portion 156 of FIG. 10C, in the circle marked on FIG. 10C. As shown in FIG. 10D, at this stage, the actuator 52 passes through the lock disengaging portion 1561 and the second portion 1552 of the first lock element 155 has been released from the lock engaging portion 1562.

FIGS. 10E, 10F and 10G illustrate how the lock disengaging portion 1561 and the lock engaging portion 1562 are deformed by the actuator 52, although the actuator 52 itself is not shown.

FIG. 10E is a viewpoint from a plane in the sample holder 11 looking toward the guard 16. In FIG. 10E, the lock is engaged and protrusions of the lock engaging portion 1562 interfere with the second portion 1552 of the first lock element 155 to prevent re-orientation of the collection tube 2.

FIG. 10F is a view through the lock assuming that the guard 16 is transparent (although this need not be the case in embodiments). As shown in FIG. 10F, when the actuator 52 moves through the lock disengaging portion 1561 (previously illustrated in FIG. 10C), the lock disengaging portion 1561 is displaced out of the path of the actuator 52. This may for example be achieved by forming the second lock element 156 as a flexible element, or by providing a compressible spring that normally biases the second lock element 156 towards an engaged position. Specifically, the lock disengaging portion 1561 in this example has wedge protrusions that are continuously displaced between an engaged position and a disengaged position.

The lock engaging portion 1562 is attached to the lock disengaging portion 1561 and is consequently also displaced by the actuator 52. When the lock disengaging portion 1561 is displaced, it no longer interferes with the second portion 1552 of the first lock element 155, and the collection tube 2 can be re-oriented.

FIG. 10G is a view of the guard 16 and the sample holder 11 after the actuator 52 has been removed from the lock disengaging portion 1561. At this stage, the lock disengaging portion 1561 and the lock engaging portion 1562 return to their respective engaged positions.

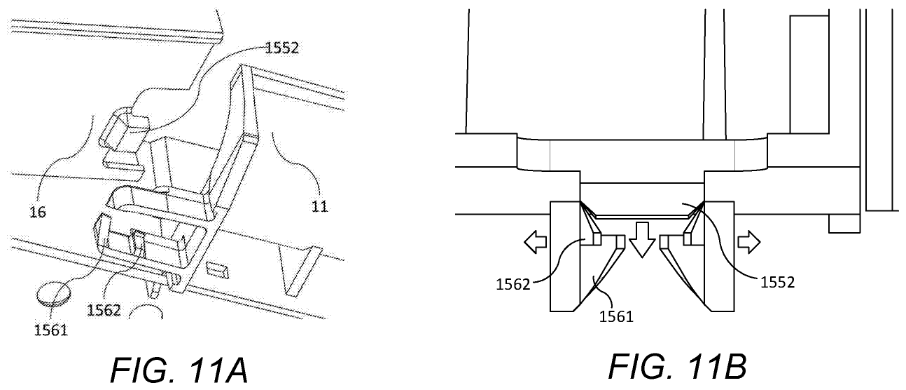

FIGS. 11A and 11B are schematic illustrations of a process of re-engaging the lock.

FIG. 11A illustrates a state of the sample holder 11 and the guard 16 prior to re-engaging the lock.

FIG. 11B includes arrows illustrating motion of the second portion 1552 of the first lock element 155 and of the lock disengaging portion 1561 and the lock engaging portion 1562 upon re-engaging the lock to return to the position shown in FIG. 10E.

More specifically, as the second portion 1552 returns to a locked position it passes through asymmetric wedge protrusions of the lock engaging portion 1562. The wedge protrusions are displaced as the second portion 1552 returns to the locked position, but interfere with the second portion 1552 without being displaced when the lock is engaged.

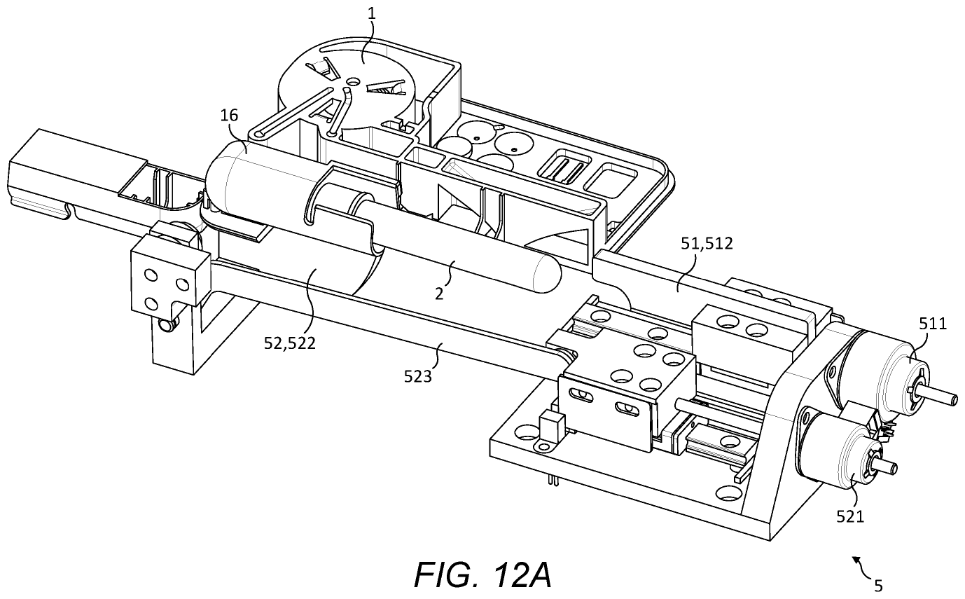

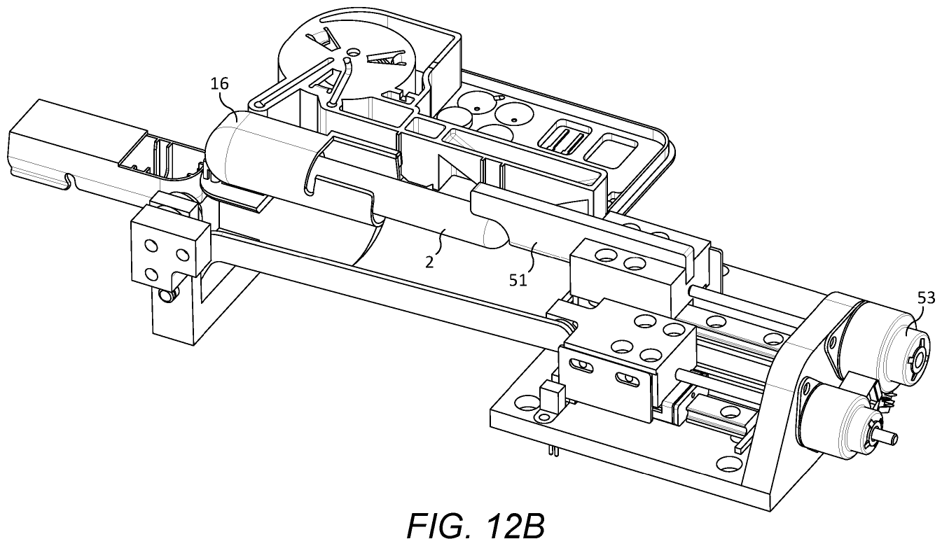

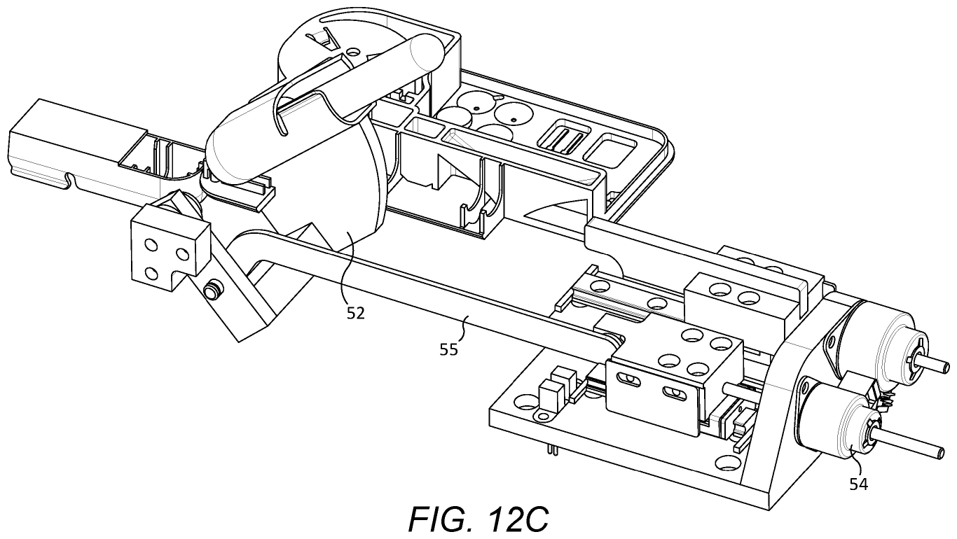

FIGS. 12A to 12C are schematic illustrations of an instrument 5 for operating the cartridge 1.

As shown in FIG. 12A, the instrument 5 comprises a first actuator 51 configured to drive the collection tube 2 to engage with the extractor 12 (hidden by the guard 16). The first actuator 51 may comprise a linear actuator 511 and an interface element 512 configured to interface with the collection tube 2. The sample holder 11 may be specifically adapted to receive the first actuator 51 by providing a space through which the first actuator 51 can drive the collection tube 2.

The instrument 5 also comprises a second actuator 52 configured to operate the re-orientation mechanism 15 to re-orient the collection tube 2 for improved extraction of the sample. The second actuator 52 may comprise a linear actuator 521 and an interface element 522 configured to interface with the re-orientation mechanism 15 (and optionally also the lock as described above, in embodiments where the lock is present). In this example, the linear actuator 521 is connected to the interface element 522 via a pivoting mechanism 523, in order to convert a linear motion into a re-orientation.

In embodiments where the re-orientation mechanism 15 has a lock, the second actuator 52 can also be configured to disengage the lock as described above.

In other embodiments, the first actuator 51 and the second actuator 52 may be provided as separate instruments, and either of the functions of the first actuator 51 and the second actuator 52 may instead be performed manually.

The instrument 5 may optionally also comprise a third actuator configured to operate a syringe 4 that is included with some embodiments of the cartridge 1, or may comprise an external driver 4, such as a syringe, configured to engage with a fluid connector 171 of the cartridge 1 for driving the driving fluid into the collection tube 2, as described above.

FIGS. 12B and 12C illustrate stages of extracting the sample.

Firstly, in FIG. 12B, the first actuator 51 drives the collection tube 2 to engage with the extractor 12 (hidden by guard 16 in the figure).

Secondly, in FIG. 12C, the second actuator 52 operates the re-orientation mechanism 15 to re-orient the collection tube 2.

The above description relates to a disposable cartridge which uses a driving fluid that is less dense than a sample. In other embodiments, the driving fluid may be more dense than the sample. The same disposable cartridge 1 may be used in this case, except it is then preferable that the first needle 121 is shorter than the second needle 122. However, this disposable cartridge 1 would require long needles in order to effectively remove the sample from the collection tube 2.

As an alternative, the above cartridge 1 may be modified such that the re-orientation mechanism is configured to re-orient the first end 22 of the collection tube 2 to be higher than the centre of the collection tube 2, for example by tilting the collection tube 2 below the plane of the cartridge 1. This may be achieved by vertically inverting the entire cartridge (either in the design or simply turning it upside down) or by specifically inverting the re-orientation mechanism 15. In this case, an extractor 12 similar to the above detailed embodiment could be used with a driving fluid that is more dense than the sample, without requiring long needles.

In the above description, situations are described in which certain elements of the disposable cartridge 1, the collection tube 2, and the syringe 4 are “connected” for fluid transfer. The skilled person will of course be aware that interruptions of the fluid connection could be added between the certain elements, and “connected” should be construed to cover elements which are connectable, subject to the state of intermediate interruptions in a fluid path.

1. A disposable cartridge for processing a biological fluid sample, the cartridge comprising:
a sample holder configured to hold a collection tube containing the sample;
an extractor configured to engage with the collection tube to transfer the sample from the collection tube to the cartridge; and
a sample processor for processing the sample.

2. A disposable cartridge according to claim 1, wherein the cartridge comprises a first channel for transporting a driving fluid into the collection tube and a second channel for transporting the sample out of the collection tube, wherein the extractor is configured to replace at least a part of the sample with the driving fluid in the collection tube.

3. A disposable cartridge according to claim 2, configured for use with a collection tube that comprises a septum, wherein the extractor comprises one or more needles configured to connect to the first and second channels.

4. A disposable cartridge according to claim 3, wherein the one or more needles are flat-tipped with a hollow core.

5. A disposable cartridge according to claim 4, wherein the one or more needles have an outer diameter of between 0.3 mm and 1 mm, and an inner diameter of between 0.15 mm and 0.6 mm, preferably an outer diameter of 0.64 mm and an inner diameter of 0.34 mm.

6. A disposable cartridge according to claim 3, wherein the one or more needles comprises a first needle configured to connect to the first channel and a second needle configured to connect to the second channel.

7. A disposable cartridge according to claim 6, wherein the first needle extends at least 5 mm beyond an end of the second needle.

8. A disposable cartridge according to claim 3, wherein the extractor comprises a recess configured to engage with the collection tube, or the extractor comprises a hub configured to engage with a recess in the collection tube.

9. A disposable cartridge according to claim 2, further comprising a syringe connected to the first channel and configured to drive the driving fluid into the collection tube.

10. A disposable cartridge according to claim 9, wherein the driving fluid is air and the cartridge further comprises an inlet for drawing air into the syringe.

11. A disposable cartridge according to claim 2, further comprising a fluid connector connected to the first channel and configured to engage with an external driver for driving the driving fluid into the collection tube.

12. A disposable cartridge according to claim 1, further comprising a re-orientation mechanism configured to re-orient the collection tube and configured to connect the extractor to the sample processor.

13. A disposable cartridge according to claim 12, wherein the extractor is configured to engage with a first end of the collection tube and the re-orientation mechanism is configured to re-orient the collection tube such that the first end is lower than a center of the collection tube.

14. A disposable cartridge according to claim 12, wherein the re-orientation mechanism comprises a first fluid directing element surrounding a second fluid directing element, wherein the first fluid directing element is configured to rotate around the second fluid directing element, and the first and second fluid directing elements are configured to connect the extractor to the sample processor when the first fluid directing element is in a first rotation position.

15. A disposable cartridge according to claim 14, wherein the re-orientation mechanism further comprises a sealed channel between the first fluid directing element and the second fluid directing element, the sealed channel being configured to connect the extractor to the sample processor when the first fluid directing element is in any of a plurality of rotation positions.

16. A disposable cartridge according to claim 14, wherein the second fluid directing elements is connected to a plurality of sample processors, and re-orientation mechanism is configured to connect the extractor to different sample processors when the first fluid directing element is in different rotation positions.

17. A disposable cartridge according to claim 12, wherein the re-orientation mechanism comprises a flexible hose configured to connect the extractor to the sample processor.

18. A disposable cartridge according to claim 12, wherein the re-orientation mechanism further comprises a lock configured to prevent re-orientation of the collection tube when engaged.

19. A disposable cartridge according to claim 18, wherein the lock is configured to disengage when operated by a second actuator.

20. A disposable cartridge according to claim 1, wherein the sample holder is configured to receive a first actuator to drive the collection tube to engage with the extractor.

21. A disposable cartridge according to claim 1, wherein the sample processor comprises a rotatable container for centrifugation.

22-25. (canceled)
